(19) United States
(12) Patent Application Publication
(10) Pub. No.: US 2026/0364624 A1
(43) Pub. Date: Nov. 19, 2026

(54) COATING DEVICE, COATING METHOD, AND PROGRAM

(71) Applicant: Takahide MAEDA, Kanagawa (JP)

(72) Inventor: Takahide MAEDA, Kanagawa (JP)

(21) Appl. No.: 19/155,273

(22) PCT Filed: Mar. 27, 2024
(86) PCT No.: PCT/IB2024/052922

§ 371 Date: Aug. 11, 2025

(30) Foreign Application Priority Data
Apr. 10, 2023 (JP) 2023-063527

(51) Int. Cl. B05B 12/12; B05B 1/14; B05B 13/04

(52) U.S. Cl. CPC B05B 12/124; B05B 1/1421; B05B 13/0433

(57) ABSTRACT

A coating device includes: a head having multiple nozzles arrayed on a nozzle surface in a nozzle array direction to discharge a liquid from each of the multiple nozzles in a discharge direction; a variable mechanism to vary a relative position and a relative posture between the head and a target surface including a curved surface; and a controller configured to: set multiple main scanning points on a main scanning line, which is an intersection line between the target surface and a cross section cut along a virtual plane, in a main scanning direction; control the variable mechanism to move the head relative to the target surface in the main scanning direction to pass through the multiple main scanning points; and control the variable mechanism to cause the nozzle array direction of the head to be along the main scanning direction to control a yaw direction of the head.

### TECHNICAL FIELD

The present disclosure relates to a coating device, a coating method, and a program.

### BACKGROUND ART

Conventionally, a coating device is known that coats a target surface by a liquid discharge method.

In addition, a coating device is disclosed that moves a nozzle for discharging a liquid along a curved surface shape of a target object in order to coat the target object having a three-dimensional shape with a coating film having a uniform thickness (see, for example, Patent Literature (PTL) 1).

### SUMMARY OF INVENTION

### Technical Problem

However, in a case where coating is performed by relatively moving a head having multiple nozzles each discharging liquid with respect to a target surface, coating quality of the device described in Patent Literature (PTL) 1 may be deteriorated due to occurrence of shift in the track of the multiple nozzles according to the movement of the head.

An object of the present disclosure is to coat a target surface including a curved surface shape with high quality by a coating device using a head including multiple nozzles each discharging liquid.

### Solution to Problem

According to an aspect of the present disclosure, a coating device includes: a head having multiple nozzles arrayed on a nozzle surface in a nozzle array direction to discharge a liquid from each of the multiple nozzles in a discharge direction; a variable mechanism to vary a relative position and a relative posture between the head and a target surface including a curved surface; and a controller configured to: set multiple main scanning points on a main scanning line, which is an intersection line between the target surface and a cross section cut along a virtual plane, in a main scanning direction;
control the variable mechanism to move the head relative to the target surface in the main scanning direction to pass through the multiple main scanning points; control the variable mechanism to cause the nozzle array direction of the head to be along the main scanning direction to control a yaw direction of the head; and control the variable mechanism to control the discharge direction of the head to be along the virtual plane to control a roll direction of the head.

### ADVANTAGEOUS EFFECTS OF INVENTION

According to the present disclosure, it is possible to coat a target surface including a curved surface shape with high quality by a coating device using a head including multiple nozzles each discharging liquid.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a schematic diagram illustrating a general arrangement of a coating device according to a first embodiment.

FIG. 2 is a block diagram illustrating a configuration example of the coating device according to the first embodiment.

FIG. 3 is a diagram illustrating a configuration of a supply mechanism of the coating device according to the first embodiment.

FIG. 4 is a perspective view illustrating a configuration of a head of the coating device according to the first embodiment.

FIG. 5 is a cross-sectional view of the head taken along a plane S1 of FIG. 4.

FIG. 6 is a diagram illustrating a functional configuration of a controller of the coating device according to the first embodiment.

FIG. 7 is a schematic top view illustrating a position of a nozzle in a case where the head curves.

FIG. 8 is a schematic top view illustrating a position of the nozzle in a case where the head goes straight.

FIG. 9 is a diagram illustrating respective directions of pitch, yaw, and roll of the head.

FIG. 10 is a diagram illustrating a landing position shift due to pitching of the head.

FIG. 11 is a diagram illustrating a landing position shift due to yawing of the head.

FIG. 12 is a diagram illustrating a landing position shift due to rolling of the head.

FIG. 13 is a diagram illustrating an inclination of the nozzle due to rolling of the head.

FIG. 14 is a diagram illustrating a virtual plane according to the embodiment.

FIG. 15 is a diagram illustrating main scanning points and sub-scanning points according to the embodiment.

FIG. 16 is a diagram illustrating a change amount of a rolling angle in a case where control is not performed such that there is no posture change in a rolling direction.

FIG. 17 is a diagram illustrating a change amount of the rolling angle in a case where control is performed such that there is no posture change in the rolling direction.

FIG. 18 is a diagram illustrating a first example of a relationship between pitching of the head and a discharge gap.

FIG. 19 is a diagram illustrating a second example of the relationship between pitching of the head and the discharge gap.

FIG. 20 is a diagram illustrating a third example of the relationship between pitching of the head and the discharge gap.

FIG. 21 is a diagram illustrating a functional configuration of a controller of a coating device according to a second embodiment.

FIG. 22 is a diagram illustrating one example of correspondence information according to the second embodiment.

FIG. 23 is a diagram illustrating a functional configuration of a controller of a coating device according to a third embodiment.

FIG. 24 is a diagram illustrating liquid discharge timing of the coating device according to the third embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below.

As used herein, the singular forms “a,” “an,” and “the” are intended to include the plural forms as well, unless the context clearly indicates otherwise.

A coating device, a coating method, and a program according to embodiments of the present embodiment will be described in detail with reference to the drawings. However, the following embodiments illustrate a coating device, a coating method, and a program for embodying the technical idea of the present embodiment, and are not limited to the following. The dimensions, materials, shapes, relative configurations and the like of the components described in the embodiments are intended to be illustrative and not limiting of the scope of the present embodiment, unless otherwise specified. The size, positional relationship, and the like of members illustrated in the drawings may be magnified for clarity of description. In the following description, the same names and reference signs indicate the same or similar members, and detailed description thereof will be omitted as appropriate.

In the following drawings, orthogonal coordinates having an X axis, a Y axis, and a Z axis may be used as direction expression. A direction along the X axis is referred to as X direction, a direction along the Y axis is referred to as Y direction, and a direction along the Z axis is referred to as Z direction. A direction in which an arrow of the X axis is directed is referred to as +X direction, and a direction opposite to the +X direction is referred to as −X direction. A direction in which an arrow of the Y axis is directed is referred to as +Y direction, and a direction opposite to the +Y direction is referred to as −Y direction. A direction in which an arrow of the Z axis is directed is referred to as +Z direction, and a direction opposite to the +Z direction is referred to as −Z direction. It is assumed that a head 1 moves in the +X direction. However, these directional expressions do not limit the directions of the embodiments of the present embodiment.

### First Embodiment

### Configuration Example of Coating Device

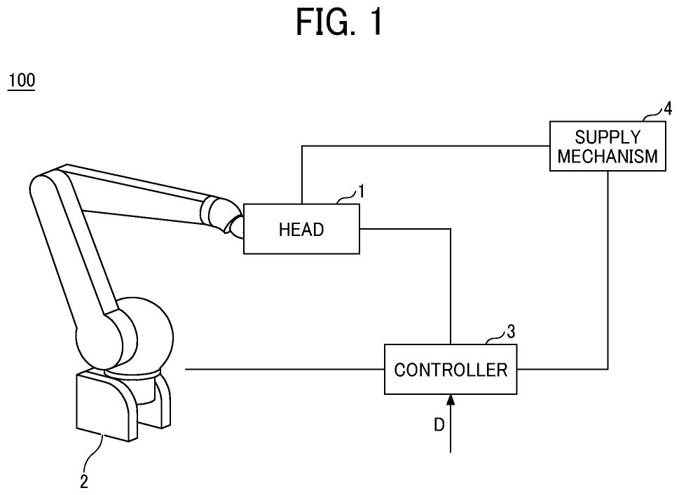

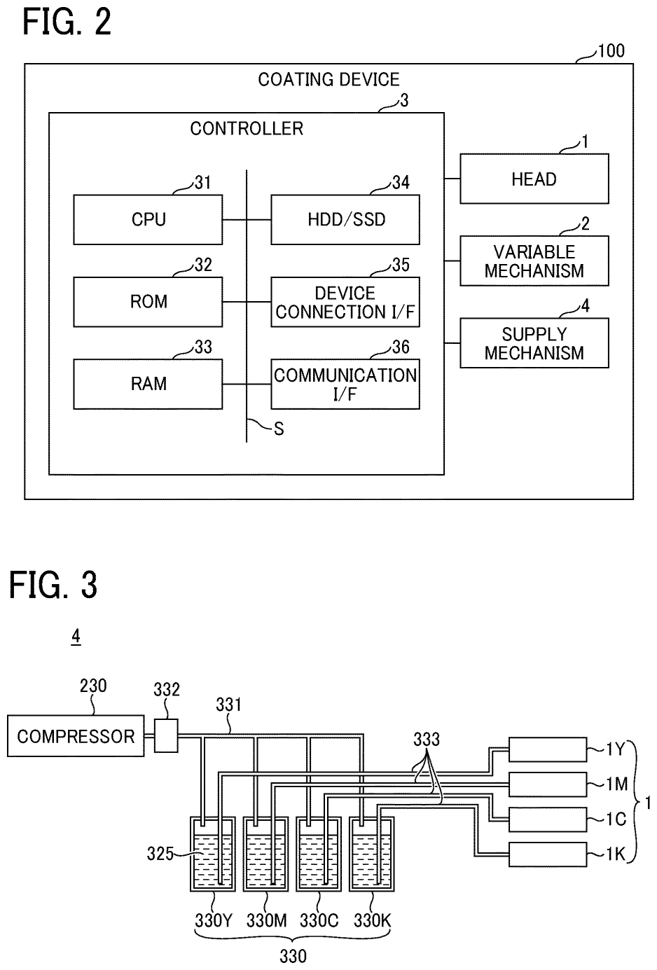

A configuration of a coating device according to an embodiment will be described with reference to FIGS. 1 to 2. FIG. 1 is a schematic diagram illustrating one example of a general arrangement of a coating device 100 according to the embodiment. FIG. 2 is a block diagram illustrating one example of a configuration of the coating device 100.

The coating device 100 coats a target surface including a curved surface shape by a liquid discharge method.

The coating device 100 can coat the target surface by applying a liquid discharged by the liquid discharge method to the target surface and sticking the liquid applied to the target surface to the target surface after drying. The liquid discharge method by the coating device 100 may be, for example, a continuous discharge method. The continuous discharge method includes a valve method for controlling discharge by opening and closing a nozzle through controlling an operation of a valve body, a continuous method for charging ink particles continuously discharged from the nozzle, bending the charged ink particles by a deflection electrode, and spraying the charged ink particles on a printing surface, and the like.

The target surface is a surface to be coated of a coating target. For example, the target surface is a surface included in a vehicle body of an automobile. Examples of coating target include vehicle, aircraft, and ship. Examples of vehicle include automobile, truck, and train. The target surface according to the embodiment includes a curved surface shape. The curved surface shape of the target surface is determined according to a design or the like of the coating target. However, the target surface may partially include a planar shape. The target surface may be a surface having impermeability. The impermeability is a property that a liquid applied to the surface to be coated does not permeate the inside. However, the target surface is not limited to a surface having impermeability, and may be a surface having permeability.

As illustrated in FIGS. 1 and 2, in the present embodiment, the coating device 100 includes the head 1, a variable mechanism 2, and a controller 3. The coating device 100 drives the variable mechanism 2 that supports the head 1 based on a shape data D of a predetermined target surface under the control of the controller 3. The coating device 100 drives the variable mechanism 2 to vary the relative position and the relative posture between the head 1 and the target surface, and discharges a liquid from the head 1 to the target surface in a discharge direction. The coating device 100 applies the liquid discharged from the head 1 to the target surface to coat the target surface.

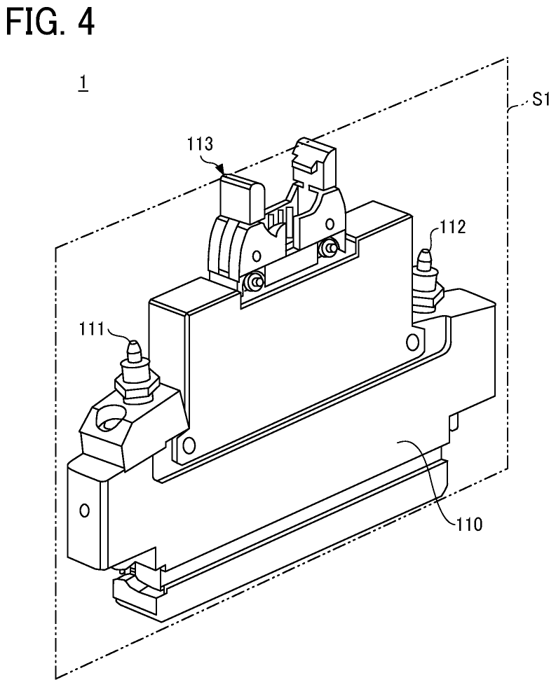

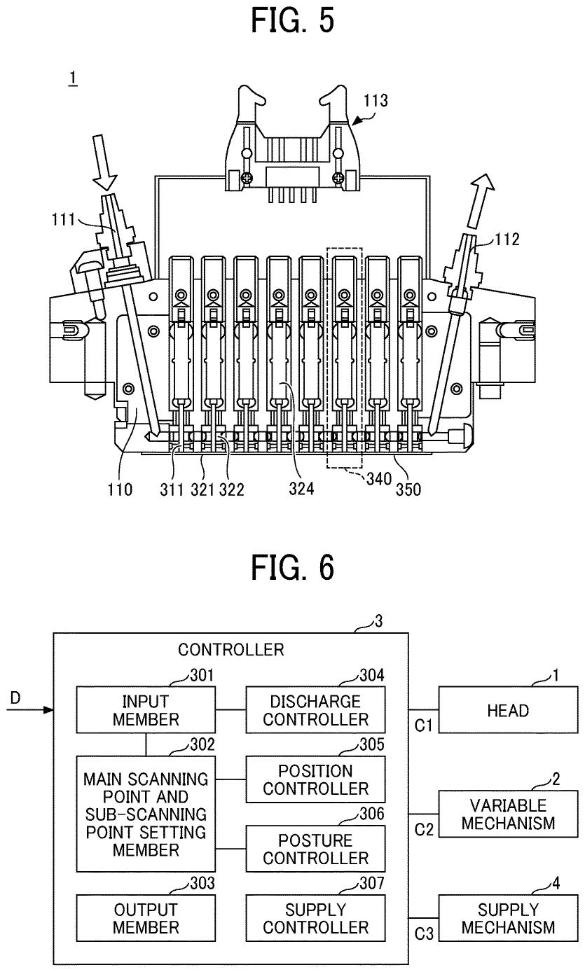

The head 1 includes multiple nozzles arranged on the nozzle surface side by side in a nozzle array direction (in the main scanning direction in FIG. 5). The head 1 can discharge liquid individually from the multiple nozzles. Note that the number of heads 1 included in the coating device 100 is not limited to one, and can be appropriately changed according to the size and shape of the target surface, the time required for coating, and the like. The configuration of the head 1 will be described in detail separately with reference to FIGS. 4 to 5.

The variable mechanism 2 varies the relative position and the relative posture between the head 1 and the target surface. In the example illustrated in the present description, the variable mechanism 2 varies the relative position between the head 1 and the target surface by moving the head 1. The variable mechanism 2 varies the posture of the head 1 to vary the relative posture between the head 1 and the target surface. However, the variable mechanism 2 may vary the relative position by moving the target surface, or may vary the relative posture by varying the posture of the target surface.

The variable mechanism 2 includes, for example, a robot arm. From the viewpoint of flexibly and accurately varying the relative position and the relative posture, the variable mechanism 2 preferably includes a robot arm having multiple drive shafts. However, the variable mechanism 2 is not limited to the robot arm, and may include a gantry mechanism, a linear motion stage, a rotation stage, or the like. The variable mechanism 2 may be configured by a combination of two or more of a robot arm, a gantry mechanism, a linear motion stage, a rotation stage, and the like. The quantity of the variable mechanism 2 is not limited to one, and can be appropriately changed according to the number of the head 1. One variable mechanism 2 may support two or more heads 1.

The controller 3 controls the discharge of liquid from the head 1 and the operation of the variable mechanism 2. For example, the controller 3 varies the relative position and the relative posture between the head 1 and the target surface and causes the head 1 to discharge liquid onto the target surface based on the shape data D of the predetermined target surface.

As illustrated in FIG. 2, the controller 3 includes a central processing unit (CPU) 31, a read only memory (ROM) 32, and a random access memory (RAM) 33. In addition, the controller 3 includes a hard disk drive (HDD)/solid state drive (SSD) 34, a device connection interface (I/F) 35, and a communication I/F 36. These components are electrically connected to communicate with each other via a system bus S.

The CPU 31 uses the RAM 33 as a work area, and controls the operation of the entire controller 3 by executing processing defined in a program stored in the ROM 32. The ROM 32 is a nonvolatile memory that stores a program for executing control such as a recording operation in the CPU 31 and other fixed data. The RAM 33 is a volatile memory that temporarily stores various data and the like used for liquid discharge by the head 1, driving of the variable mechanism 2, and the like. An HDD/SSD 34 is a nonvolatile memory that stores the shape data D of a target object surface, image data of a picture, a character, or the like when the picture, the character, or the like is drawn on the target surface, and the like.

The device connection I/F 35 is an interface for communicably connecting to each of the head 1, the variable mechanism 2, and a supply mechanism 4. The communication I/F 36 is an interface for communicably connecting an external device such as a host personal computer (PC) and the controller 3.

The supply mechanism 4 in FIGS. 1 to 2 supplies the liquid discharged from the head 1 to the head 1. The configuration of the supply mechanism 4 will be described in detail separately with reference to FIG. 3.

The coating device 100 may have, for example, a maintenance mechanism in addition to the configuration illustrated in FIGS. 1 to 2. The maintenance mechanism maintains the state of liquid discharge by the head 1. The maintenance mechanism includes a wiper that wipes a nozzle surface of the head 1, a suction pump that sucks the liquid from the inside of the head 1, and the like. The maintenance mechanism uses the wiper, the suction pump, and the like to remove mucilaginous fluid and foreign matter which adhere to the nozzle surface, or mucilaginous fluid, foreign matter, etc. existing inside the head 1. By removing the mucilaginous fluid, foreign matter, etc., the maintenance mechanism can reduce discharge abnormality such as non-discharge, discharge deflection, or discharge speed variation of the head 1, and can maintain the discharge state of the head 1 in a normal state.

In addition to the above, the coating device 100 may include a display that displays a setting screen and the like of a condition and the like of the liquid application by the coating device 100, an operation member that is an operation input device such as a touch panel, a keyboard, and a mouse that receive an operation of the coating device 100, and the like.

### Configuration Example of Supply Mechanism

FIG. 3 is a diagram illustrating one example of a configuration of the supply mechanism 4.

The head 1 includes a head 1Y that discharges a yellow (Y) liquid, a head 1M that discharges a magenta (M) liquid, a head 1C that discharges a cyan (C) liquid, and a head 1K that discharges a black (K) liquid. The head 1 may further include a head that discharges an overcoat liquid or a head that discharges another liquid such as a head that discharges a primer liquid or a white liquid in addition to the head that discharges the liquid of each of the colors. The supply mechanism 4 can supply the liquid of each of the colors to the head 1.

The supply mechanism 4 includes a liquid tank 330 as a sealed container that stores a liquid 325 of each of the colors, which is discharged from the head 1. The liquid tank 330 and an injection port (supply port) of the head 1 are connected to each other through a tube 333 in a manner that liquid can flow therethrough.

On the other hand, the liquid tank 330 is connected to a compressor 230 via a pipe 331 including an air regulator 332, and the compressor 230 supplies pressurized air. Thus, the pressurized liquid 325 of each of the colors is supplied to the injection port of the head 1, and the coating device 100 discharges the liquid 325 from the nozzle of the head 1.

### Configuration Example of Head

FIGS. 4 and 5 are diagrams illustrating one example of the configuration of the head 1. FIG. 4 is a perspective view. FIG. 5 is a cross-sectional view of the head 1 taken along a plane S1 of FIG. 4.

As illustrated in FIGS. 4 and 5, the head 1 has multiple discharge modules 340 arranged in one row or multiple rows in the housing 110.

The head 1 includes a supply port 111 and a collection port 112, the supply port 111 supplies pressurized liquid to the discharge modules 340 from the outside, and the collection port 112 discharges liquid that has not been discharged to the outside. The housing 110 includes a connector 113.

As illustrated in FIG. 5, each discharge module 340 includes a nozzle plate 321 including a nozzle 311 that discharges liquid, a channel 322 that communicates with the nozzle 311 and supplies pressurized liquid, and a piezoelectric element 324 that drives a needle-shaped valve body that opens and closes the nozzle 311. A nozzle surface 350 corresponds to the surface of the nozzle plate 321 in the direction in which the liquid is discharged.

The nozzle plate 321 is joined to the housing 110. The channel 322 is a common channel for the multiple discharge modules 340 in the housing 110. The coating device 100 supplies the pressurized liquid from the supply port 111 through the channel 322 and discharges the liquid from the collection port 112. During the period in which the liquid is discharged to the target surface, the liquid may not be temporarily discharged from the collection port 112 in order not to lower the discharge efficiency of the liquid from the nozzle 311.

### Functional Configuration Example of Controller

FIG. 6 is a block diagram illustrating one example of a functional configuration of the controller 3. The controller 3 includes an input member 301, a main scanning point and sub-scanning point setting member 302, an output member 303, a discharge controller 304, a position controller 305, a posture controller 306, and a supply controller 307.

The functions of the input member 301 and the output member 303 are implemented by the device connection I/F 35, the communication I/F 36, and the like of FIG. 2. The functions of the main scanning point and sub-scanning point setting member 302, the discharge controller 304, the position controller 305, the posture controller 306, and the supply controller 307 are implemented by the CPU 31 loading a program, which is stored in the ROM 32, into the RAM 33 and executing processing defined in the program, etc. Note that a configuration other than the controller 3 such as the head 1 may have at least a part of the functions of the controller 3. At least a part of the functions of the controller 3 may be implemented by distributed processing between the controller 3 and components other than the controller 3.

The input member 301 inputs the shape data D of the target surface from an external device by controlling communication with the external device. The input member 301 may receive the shape data D from an external PC or the like via a network such as the Internet, or may input the shape data D using a portable memory such as a universal serial bus (USB) memory.

The main scanning point and sub-scanning point setting member 302 sets main scanning points and sub-scanning points based on the shape data D of the target surface. The main scanning points are multiple points set on a main scanning line which is an intersection line between the target surface and a cross section when the target surface is cut along a predetermined virtual plane. The main scanning points are set as points through which the head 1, which is relatively moved in the main scanning direction by the variable mechanism 2, passes. The sub-scanning points are multiple points set on a sub-scanning line that passes through a main scanning point having the largest curvature radius of the target surface among the multiple main scanning points included in the main scanning line and extends in a sub-scanning direction intersecting the main scanning direction. The sub-scanning points are set as points, through which the head 1, which is relatively moved in the sub-scanning direction by the variable mechanism 2, passes.

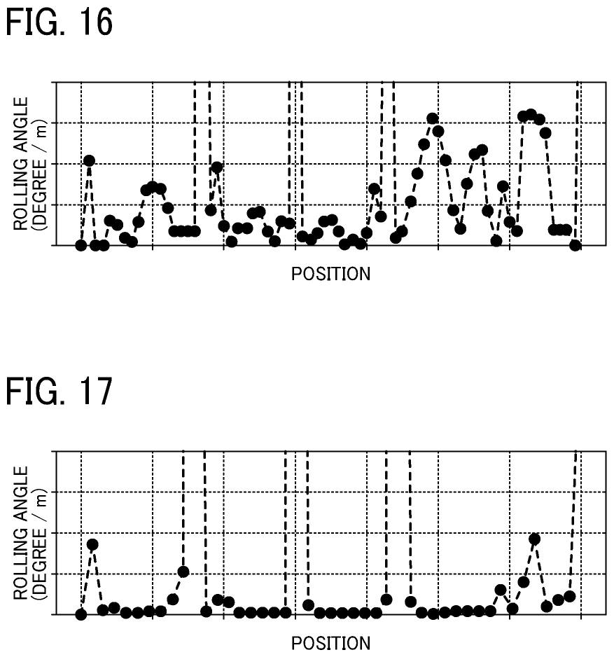

In addition, the sub-scanning points are set for each predetermined distance by which the head 1 relatively moves continuously once in the sub-scanning direction, that is, for each line feed pitch. The main scanning point and sub-scanning point setting member 302 sets the main scanning points and the sub-scanning points as three-dimensional spatial coordinates, respectively. A method for setting the main scanning points and the sub-scanning points by the main scanning point and sub-scanning point setting member 302 will be described in detail separately with reference to FIGS. 15 to 16. Instead of the main scanning point and sub-scanning point setting member 302, the controller 3 may separately include a main scanning point setting member that sets only the main scanning points and a sub-scanning point setting member that sets only the sub-scanning points.

The controller sets multiple main scanning points on a main scanning line, which is an intersection line between the target surface and a cross section cut along a virtual plane, in a main scanning direction.

The controller sets multiple sub-scanning points on a sub-scanning line in the sub-scanning direction, wherein the multiple sub-scanning points passes through one of the main scanning points having a largest curvature radius of the target surface among the multiple main scanning points in the main scanning line.

The output member 303 controls communication with each of the head 1, the variable mechanism 2, and the supply mechanism 4 to output each of a discharge control signal C1, an operation control signal C2, and a supply control signal C3 from the controller 3. The discharge control signal C1 is a signal for controlling discharge of liquid by the head 1. The operation control signal C2 is a signal for controlling operation of the variable mechanism 2. The supply control signal C3 is a signal for controlling liquid supply by the supply mechanism 4.

The discharge controller 304 outputs the discharge control signal C1 via the output member 303 to control discharge of liquid from the head 1. The discharge controller 304 can control selection of the nozzle for discharging liquid among multiple nozzles of the head 1, timing of discharging liquid from the nozzle, a discharge frequency and an amount of liquid discharged from the nozzle, and the like.

The position controller 305 controls the position of the head 1, which is relatively moved by the variable mechanism 2, by outputting the operation control signal C2 via the output member 303. In the present embodiment, the position controller 305 controls the relative movement of the head 1 in the main scanning direction in a manner that the head 1 passes through the multiple main scanning points set by the main scanning point and sub-scanning point setting member 302.

The posture controller 306 outputs the operation control signal C2 via the output member 303 to control the relative posture of the head 1 which is varied by the variable mechanism 2. In the present embodiment, the posture controller 306 controls the relative posture of the head 1 in a manner that the normal direction of the front surface of the head 1 in the main scanning direction is along the main scanning direction in the yaw direction and the normal line of the nozzle surface 350 is along the virtual plane in the roll direction.

Note that the controller 3 may include a functional configuration having the functions of both the position controller 305 and the posture controller 306 instead of the position controller 305 and the posture controller 306.

The supply controller 307 controls the supply of liquid from the supply mechanism 4 to the head 1 by outputting the supply control signal C3 via the output member 303. The supply controller 307 can control, for example, selection of the color of the liquid to be supplied to the head 1, the supply timing, the supply amount, and the like.

The controller 3 may be divided into a robot control panel that controls the operation of the variable mechanism 2, a discharge control device that controls the discharge of liquid by the head 1, and a PC that controls the whole. For example, the robot control panel has the functions of the main scanning point and sub-scanning point setting member 302, the position controller 305, and the posture controller 306 of FIG. 6. The discharge control device has the functions of the discharge controller 304 and the supply controller 307 of FIG. 6. The PC has a function of integrally controlling the robot control panel and the discharge control device.

The robot control panel and the discharge control device are connected to each other in a wired or wireless manner so that information held by the robot control panel can be output to the discharge control device. The PC generates a robot program for controlling the robot control panel, and transmits the robot program to the robot control panel before coating. Further, the PC generates coating data for controlling the discharge control device, and transmits the coating data to the discharge control device before coating. When the PC detects the start of coating in response to an operation input or the like by the operator, the PC instructs the robot control panel to start executing the robot program. The coating device 100 can coat the target surface 200 by controlling the discharge from the head 1 by the discharge control device in synchronization with the operation of the variable mechanism 2 as a robot.

The program language of the robot is developed for each robot manufacturer. An operator of the robot can create a program suitable for the robot to be used. One example of the robot program language input to the robot control panel is described below.
MOVJ X=100 Y=50 Z=0 A=0 B=45 C=30
   This command moves the head 1 to X=100 Y=50 Z=0 in each axis operation. A, B and C denote the angles of the head 1.
MOVL X=200 Y=80 Z=11 A=0 B=30 C=0
   This command moves the head 1 to X=200 Y=80 Z=11 by linear interpolation. A, B and C denote the angles of the head 1.

Method for controlling position and posture of head by controller Next, a method for controlling the position and posture of the head 1 by the controller 3 will be described.

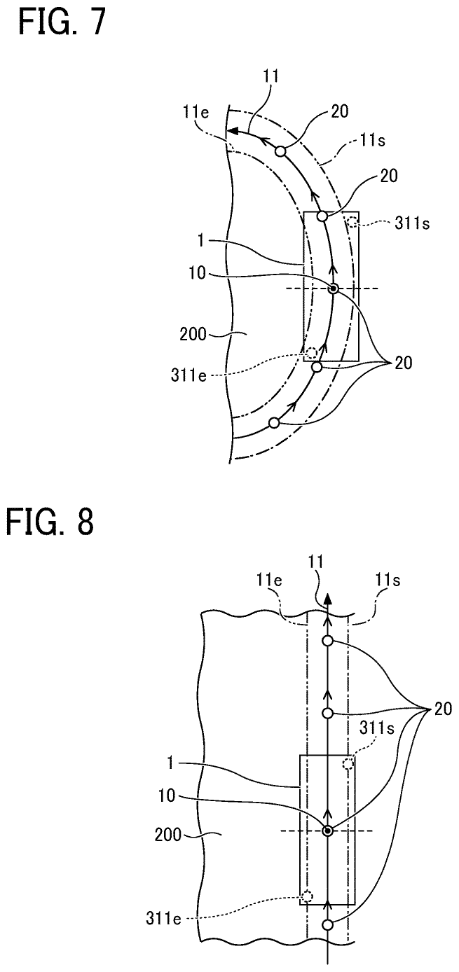

First, prior to the description of the control method by the controller 3, a phenomenon in which the position where the liquid discharged from the head 1 lands on the target surface is shifted when the target surface including the curved surface shape is coated will be described with reference to FIGS. 7 to 13.

### Position Shift of Nozzle Accompanying Movement of Head

FIG. 7 is a schematic top view illustrating the position of the nozzle in a case where the head 1 curves. FIG. 8 is a schematic top view illustrating the position of the nozzle in a case where the head 1 goes straight. FIGS. 7 to 8 schematically illustrate a state in which the head 1 moved by the variable mechanism 2 illustrated in FIG. 1 to coat the target surface 200 is viewed from above the head 1.

In FIGS. 7 to 8, a head center 10 is a center of the head 1 in top view. A front nozzle 311s is a nozzle located at the foremost position in the moving direction of the head 1 among the multiple nozzles 311 provided in the head 1. A rear nozzle 311e is a nozzle located at the rearmost position in the moving direction of the head 1 among the multiple nozzles 311 included in the head 1. Teaching points 20 indicate points through which the head 1 passes. The head 1 is moved by the variable mechanism 2 in a manner that the head center 10 passes over the teaching points 20.

An ideal center track 11 indicated by a solid line is an ideal track through which the head center 10 passes when the head 1 is moved along the teaching points 20. An ideal front nozzle track 11s indicated by a one-dot chain line is an ideal track through which the front nozzle 311s passes when the head 1 is moved along the teaching points 20. An ideal rear nozzle track 11e indicated by a two-dot chain line is an ideal track through which the rear nozzle 311e passes when the head 1 is moved along the teaching points 20.

As illustrated in FIG. 7, when the head 1 curves without changing its posture, the position of the front nozzle 311s shifts from the ideal front nozzle track 11s, and the position of the rear nozzle 311e shifts from the ideal front nozzle track 11s. Note that the curving includes movement that draws an arc and movement that bends, such as left turn or right turn.

There are ideal tracks corresponding to each of all the nozzles 311 included in the head 1. When the head 1 curves without changing its posture, position shifts from the ideal tracks occur in all the nozzles 311 included in the head 1. Due to the position shifts of the nozzles 311 with respect to the ideal tracks, coating omission in which liquid is not applied and thus not coated onto the target surface 200 may occur. When the posture of the head 1 is controlled according to the curving of the head 1 so that coating omission does not occur at any of the multiple nozzles 311 included in the head 1, the control becomes complicated.

On the other hand, as illustrated in FIG. 8, when the head 1 goes straight without curving, position shifts from the ideal tracks do not occur at any of the nozzles 311 included in the head 1.

### Landing Position Shift Due to Posture Variation Accompanying Movement of Head

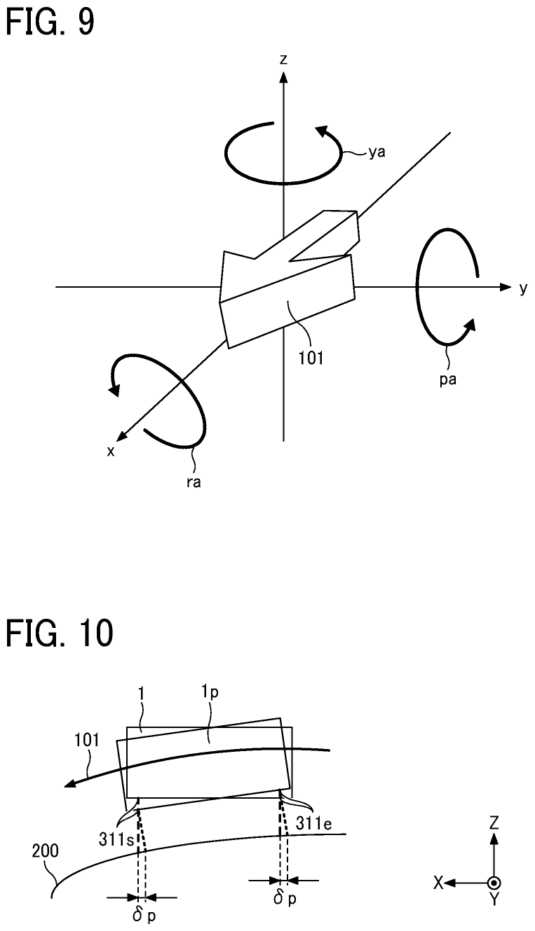

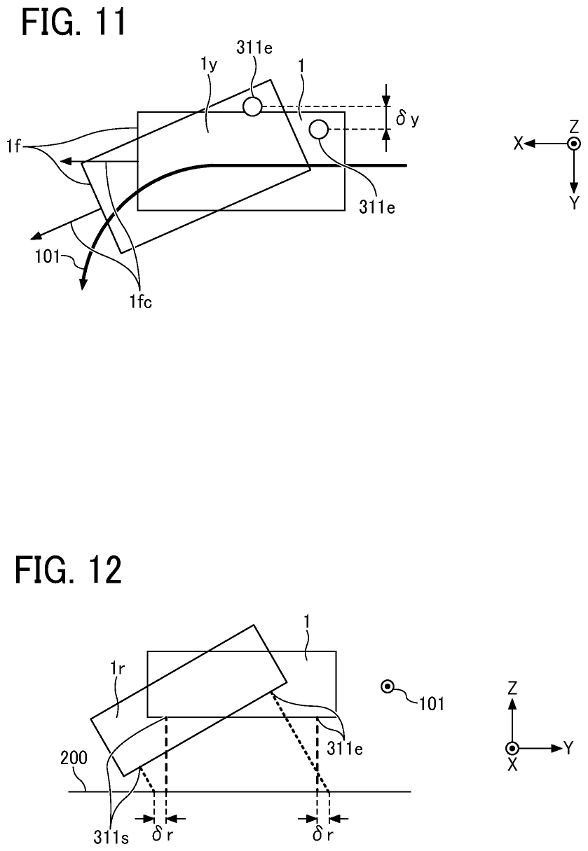

FIG. 9 is a diagram illustrating respective directions of pitch, yaw, and roll of the head 1. FIG. 10 is a diagram illustrating a landing position shift due to pitching of the head 1. FIG. 11 is a diagram illustrating a landing position shift due to yawing of the head 1. FIG. 12 is a diagram illustrating a landing position shift due to rolling of the head 1.

As illustrated in FIG. 9, a moving direction 101 is the moving direction of the head 1. A pitch direction pa is a posture direction around the Y axis. The yaw direction ya is a posture direction around the Z axis. The roll direction ra is a posture direction around the X axis.

FIG. 10 illustrates a state in which the head 1 moved in the +X direction is viewed from the +Y direction side. The head 1 is a head without pitching. A head 1p is a head with pitching. A thick broken line indicates a discharge direction of liquid discharged from each of the front nozzle 311s and the rear nozzle 311e of the head 1. A thin broken line indicates a discharge direction of liquid discharged from each of the front nozzle 311s and the rear nozzle 311e of the head 1p.

As illustrated in FIG. 10, in a state where there is pitching, as compared with a state where there is no pitching, a landing position shift &p according to the pitching angle occurs corresponding to the liquid discharged from the nozzles such as the front nozzle 311s and the rear nozzle 311e. The landing position is a position where the liquid discharged from the nozzle 311 lands on the target surface 200. The landing position shift Sp is a shift of the landing position with respect to an ideal landing position.

FIG. 11 illustrates a state in which the head 1 moved in the +X direction is viewed from the +Z direction side. The head 1 is a head without yawing. A head ly is a head with yawing. A front surface 1f is a front surface of the head 1 in the main scanning direction. A normal line 1fc is a normal line of the front surface 1f. As illustrated in FIG. 11, in a state where there is yawing, as compared with a state where there is no yawing, a landing position shift y according to the yawing angle occurs corresponding to the liquid discharged from the nozzles such as the rear nozzle 311e.

FIG. 12 illustrates a state in which the head 1 moved in the +X direction is viewed from the +X direction side. The head 1 is a head without rolling. A head 1r is a head with yawing. A thick broken line indicates a discharge direction of liquid discharged from each of the front nozzle 311s and the rear nozzle 311e of the head 1. A thin broken line indicates a discharge direction of liquid discharged from each of the front nozzle 311s and the rear nozzle 311e of the head 1r.

As illustrated in FIG. 12, in a state where there is rolling, as compared with a state where there is no rolling, a landing position shift &r according to the rolling angle occurs corresponding to the liquid discharged from the nozzles such as the front nozzle 311s and the rear nozzle 311e.

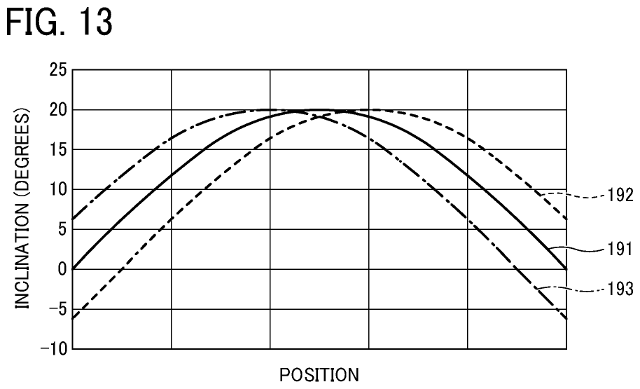

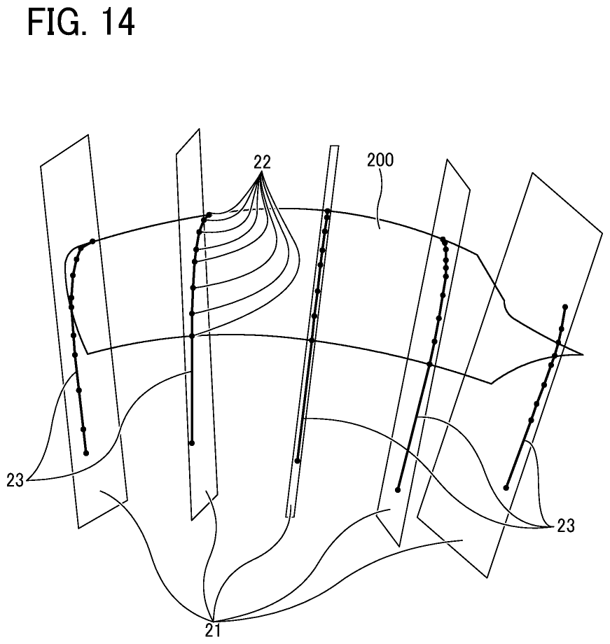

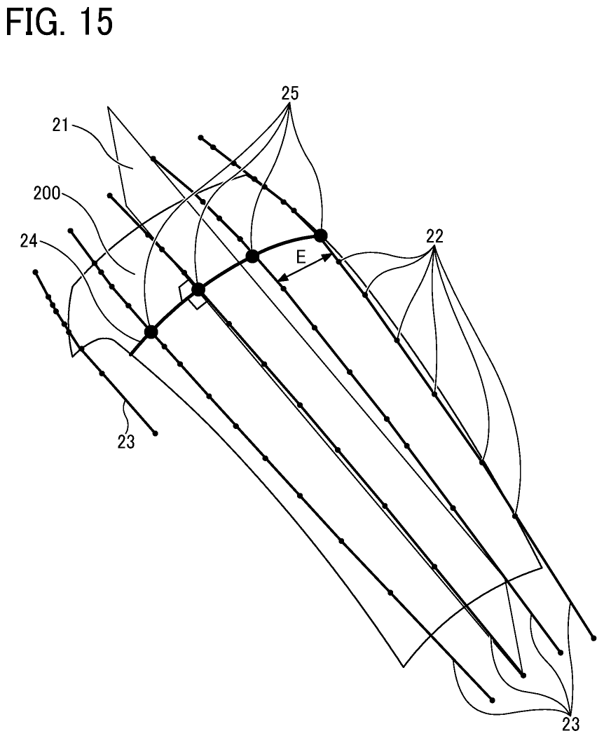

FIG. 13 is a diagram illustrating an inclination of the nozzle 311 due to rolling of the head 1. In FIG. 13, the horizontal axis indicates the position of the head 1 to be moved, and the vertical axis indicates the inclination (degree) of the nozzle 311.

In FIG. 13, a graph 191 indicated by a solid line indicates the inclination of the nozzle 311 positioned at the head center 10. A graph 192 indicated by a broken line indicates the inclination of the front nozzle 311s. A graph 193 indicated by a one-dot chain line indicates the inclination of the rear nozzle 311e. As illustrated in FIG. 13, the inclination of the multiple nozzles 311 included in the head 1 varies depending on rolling of the head 1. Further, the multiple nozzles 311 included in the head 1 has different inclinations due to rolling of the head 1 according to positions where the nozzles are respectively arranged in the head 1.

It is desirable that the posture of the head 1 is set to a state in which the discharge direction of the liquid from the head 1 is substantially parallel to the normal direction of the target surface 200. However, when the head 1 includes the multiple nozzles 311 and the nozzles 311 are arranged at positions separated in the main scanning direction of the head 1, a problem similar to the case where the track of the head 1 is bent in a plane perpendicular to the discharge direction vector of the liquid also occurs in the posture change in the rolling direction ra.

For example, when the target surface 200 has a twisted shape in which the component perpendicular to the normal direction of the target surface 200 changes along the main scanning direction, the liquid discharge direction becomes substantially parallel to the normal direction of the target surface 200 at the position of the head center 10. However, the liquid discharge direction of the nozzle 311, which is disposed at a position away from the head center 10 in the main scanning direction, is not substantially parallel to the normal direction of the target surface 200. As a result, the landing position of the liquid discharged from the nozzle 311 may be shifted from the ideal position.

### Control Method by Controller

FIG. 14 is a diagram illustrating one example of a virtual plane 21 used in the control by the controller 3. FIG. 15 is a diagram illustrating one example of main scanning points 22 and sub-scanning points 25.

In FIGS. 14 to 15, the virtual plane 21 cuts the target surface 200. The virtual plane 21 is determined in advance based on the shape data D of the target surface 200. A main scanning line 23 is an intersection line between the target surface 200 and a cross section obtained by cutting the target surface 200 along the virtual plane 21. The multiple main scanning points 22 is set on the main scanning line 23 by the main scanning point and sub-scanning point setting member 302 illustrated in FIG. 6. The position controller 305 illustrated in FIG. 6 controls the relative movement of the head 1 in the main scanning direction in a manner that the head 1 passes through the multiple main scanning points 22. The main scanning direction corresponds to the extending direction of the main scanning line 23.

On the other hand, in FIG. 15, a sub-scanning line 24 is a line that passes through the main scanning points 22 located in the region having the largest curvature radius of the target surface 200 among the multiple main scanning points 22 included in the main scanning line 23 and extends in the sub-scanning direction intersecting the main scanning direction. The sub-scanning points 25 are set on the sub-scanning line 24 by the main scanning point and sub-scanning point setting member 302 illustrated in FIG. 6. The virtual plane 21 includes one of the multiple sub-scanning points 25.

In the present embodiment, regardless of the curved surface shape of the target surface 200, the controller 3 alternately performs the continuous relative movement of the head 1 in the main scanning direction and the continuous relative movement of the head 1 in the sub-scanning direction, and performs coating by controlling the head 1 to discharge liquid. Thus, since the head 1 can be moved straight to perform coating, as described with reference to FIGS. 7 to 8, coating can be performed without causing position shift from an ideal track in all the nozzles 311 included in the head 1. In other words, in the present embodiment, with respect to the posture of the head 1, coating can be performed in a state in which there is no posture change of the head 1 in the yawing direction ya and the main scanning line 23 is not bent left and right with respect to the moving direction of the head 1 in the plane parallel to the nozzle surface 350. Thus, in the present embodiment, the target surface 200 including the curved surface shape can be coated with high quality by the coating device 100 using the head 1 having the multiple nozzles 311 each discharging liquid. The effect of the present embodiment is particularly remarkable when the normal direction of the target surface 200 differs depending on the position in the main scanning direction.

In the present embodiment, the sub-scanning line 24 serving as a reference is defined on the target surface 200 in a direction intersecting a direction in which the head 1 is desired to be moved, that is, a path direction. Subsequently, the sub-scanning points 25 spaced apart by a line feed pitch E (see FIG. 15) in the sub-scanning direction are defined on the sub-scanning line 24.

On each of the sub-scanning points 25, a vector in the direction of the sub-scanning line 24 is defined, and a plane orthogonal to the vector is defined as the virtual plane 21 used to acquire the cross section. It is desirable that the sub-scanning line 24 at this time is a line obtained by projecting a straight line onto the target surface 200 and is set in a region where the curvature radius of the target surface 200 is the largest. By setting the sub-scanning line 24 in the region where the curvature radius is the largest, spread of multiple virtual planes 21 can be suppressed, and the line feed pitch E in the sub-scanning direction can be set within the coating width that can be coated by the head 1.

In the present embodiment, the posture of the head 1 is controlled so that there is no posture change in the rotation component orthogonal to the main scanning direction, that is, the rolling component, in the movement of the head 1 in the main scanning direction. Here, FIG. 16 is a diagram illustrating a change amount of the rolling angle in a case where control is not performed so that there is no posture change in the rolling direction ra. FIG. 17 is a diagram illustrating a change amount of the rolling angle in a case where control is performed so that there is no posture change in the rolling direction ra. The rolling angle (degree/m) in FIG. 17 is reduced as compared to the rolling angle (degree/m) in FIG. 16. Examples of the method for controlling the head 1 for obtaining the result of FIG. 17 include manually adjusting the posture of the head 1 for each teaching point, collectively unifying by numerical calculation, and the like, but the means thereof is not limited. Examples of the orientation of the posture of the head 1 to be corrected include a method in which the orientation is perpendicular to the cross section, a method in which the average of the incident angles of the liquid at each landing position is closest to the normal line, and a method in which the maximum value is the smallest, but the target value thereof is not limited.

In the present embodiment, the line feed pitch E corresponding to the length of the distance by which the head 1 relatively moves once continuously in the sub-scanning direction is shorter than the length of the coating width, which is the width in the sub-scanning direction of the region to be coated by the head 1 relatively moving once continuously in the main scanning direction. By making the line feed pitch E shorter than the coating width, the continuous relative movement of the head 1 in the main scanning direction and the continuous relative movement of the head 1 in the sub-scanning direction intersecting the main scanning direction are alternately performed, and when the head 1 is controlled to discharge liquid, coating can be performed while preventing coating omission.

The controller controls the variable mechanism to alternately perform: continuously moving the head relative to the target surface in the main scanning direction; and moving the head relative to the target surface in a sub-scanning direction intersecting the main scanning direction after one continuous movement of the head in the main scanning direction, while causing the head to discharge the liquid, the head moves relative to the target surface once in the sub-scanning direction for a line feed pitch, the head moves continuously relative to the target surface in the main scanning direction while coating the target surface with a coating width in the sub-scanning direction, and the line feed pitch is shorter than the coating width.

Here, when the posture of the moved head 1 changes in the pitch direction pa, a nozzle 311 having a large discharge gap may occur among the multiple nozzles 311 included in the head 1. The discharge gap is a distance between the nozzle surface 350 and the target surface 200 in the normal direction of the nozzle surface 350 of the head 1. When the discharge gap becomes larger than a predetermined discharge gap, the landing position may shift from the predetermined position by the time taken for the liquid discharged from the nozzle 311 to reach the target surface 200. In addition, the landing position may shift from the predetermined position due to the flight direction being bent during flight until the liquid reaches the target surface 200. The coating quality may be deteriorated due to these landing position shifts.

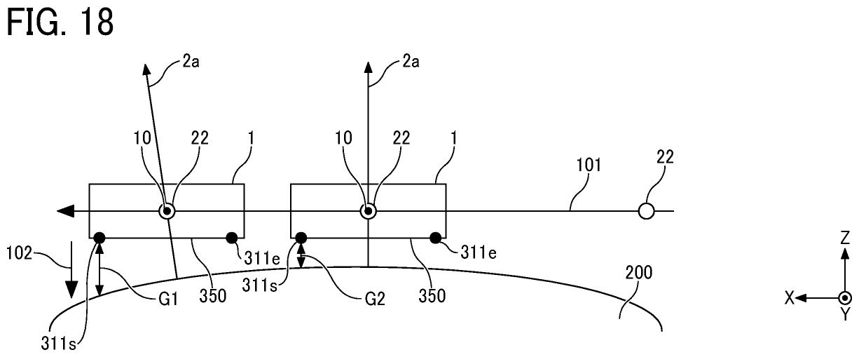

FIGS. 18 to 20 are diagrams for describing a relationship between the posture change in the pitch direction pa and the discharge gap as the head 1 moves. In FIGS. 18 to 20, a nozzle surface normal direction 102 indicates the normal direction of the nozzle surface 350 of the head 1. A target surface normal direction 200a indicates the normal direction of the target surface 200.

FIG. 18 illustrates a discharge gap in a case where the head 1 is linearly moved not along the curved surface of the target surface 200 and the posture control of the head 1 in a pitching direction pa is not performed. As illustrated in FIG. 18, the head 1 does not move along the curved surface of the target surface 200, and thus, a difference between a discharge gap G1 and a discharge gap G2 is large.

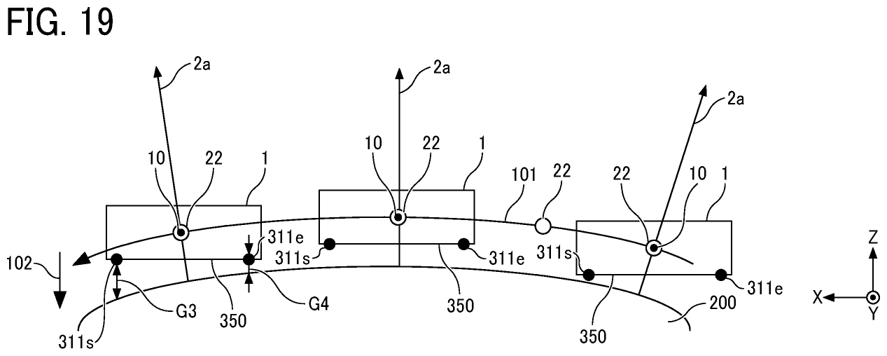

FIG. 19 illustrates a discharge gap in a case where the head 1 is moved along the curved surface of the target surface 200 and the posture control of the head 1 in the pitching direction pa is not performed. That is, in the example illustrated in FIG. 19, the controller 3 moves the head 1 in the main scanning direction in a manner that the distance between the nozzle surface 350 and the target surface 200 in the normal direction of the target surface 200 is predetermined.

As illustrated in FIG. 19, the head 1 moves along the curved surface of the target surface 200, and thus, a difference between a discharge gap G3 and a discharge gap G4 is smaller than the difference between the discharge gap G1 and the discharge gap G2 in FIG. 18. However, in the example of FIG. 19, the nozzle surface normal direction 102 is not substantially parallel to the target surface normal direction 200a, and thus, there is room for improvement in the difference between the discharge gap G3 and the discharge gap G4.

The controller moves the head relative to the target surface in the main scanning direction; and keeps a distance between the nozzle surface and the target surface in a normal direction normal to the target surface to be a predetermined distance.

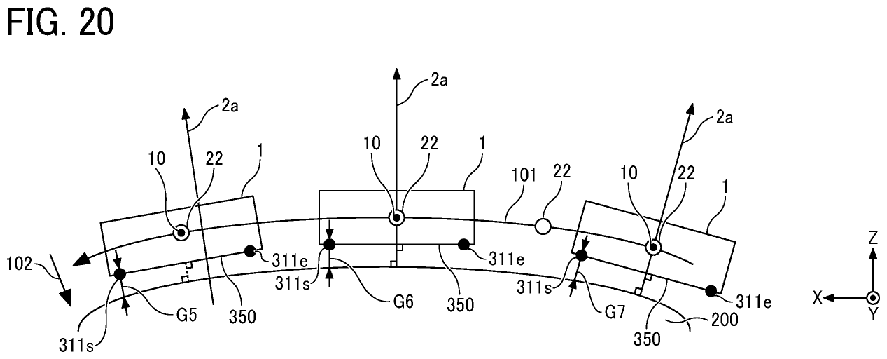

FIG. 20 illustrates a discharge gap in a case where the head 1 is moved along the curved surface of the target surface 200 and the posture control of the head 1 in the pitching direction pa is performed. That is, in the example of FIG. 20, in addition to the control in the example illustrated in FIG. 19, the controller 3 moves the head 1 in the main scanning direction in a manner that the normal direction of the nozzle surface 350 is along the normal direction of the target surface 200 in the pitch direction pa. As illustrated in FIG. 20, the head 1 moves along the curved surface of the target surface 200 and the nozzle surface normal direction 102 is substantially parallel to the target surface normal direction 200a, and thus, differences among a discharge gap G5, a discharge gap G6, and a discharge gap G7 are relatively smaller. Thereby, the bending of the discharged liquid and the variation in the discharge speed can be reduced, and thus, the landing position shift of the liquid on the target surface 200 can be reduced and the coating quality can be improved.

A coating device includes: a head (1) having multiple nozzles (311) arrayed on a nozzle surface (350) in a nozzle array direction to discharge a liquid from each of the multiple nozzles (311) in a discharge direction; a variable mechanism (2) to vary a relative position and a relative posture between the head (1) and a target surface (200) including a curved surface; and a controller (3) configured to: set multiple main scanning points (22) on a main scanning line, which is an intersection line between the target surface and a cross section cut along a virtual plane (21), in a main scanning direction; control the variable mechanism (2) to move the head (1) relative to the target surface in the main scanning direction to pass through the multiple main scanning points; control the variable mechanism (2) to cause the nozzle array direction of the head to be along the main scanning direction to control a yaw direction (ya) of the head; and control the variable mechanism (2) to control the discharge direction of the head to be along the virtual plane to control a roll direction (ra) of the head.

### Second Embodiment

Next, a coating device according to a second embodiment will be described. Note that the same names and reference signs as those of the embodiment and the modification described above indicate the same or similar members or components, and detailed description thereof will be appropriately omitted. The same applies to other embodiments described below.

The present embodiment is mainly different from the first embodiment in that the controller controls the relative posture of the head based on correspondence information in which the respective positions of the multiple main scanning points and the multiple sub-scanning points are associated with the relative posture of the head.

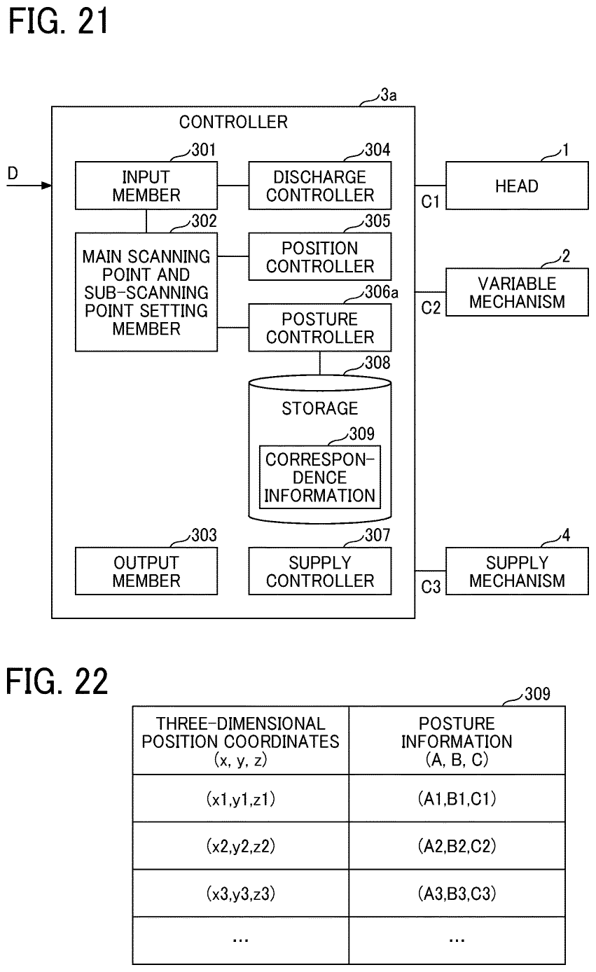

A functional configuration of a controller 3a included in the coating device according to the present embodiment will be described with reference to FIGS. 21 to 22. FIG. 21 is a block diagram illustrating one example of the functional configuration of the controller 3a. FIG. 22 is a diagram illustrating one example of the correspondence information according to the present embodiment.

As illustrated in FIG. 21, the controller 3a includes a posture controller 306a and a storage 308.

The function of the posture controller 306a is implemented by, for example, the CPU 31 illustrated in FIG. 2 loading a program stored in the ROM 32 into the RAM 33 and executing processing defined in the program. The function of the storage 308 is implemented by the HDD/SSD 34, etc. illustrated in FIG. 2.

The storage 308 stores a correspondence information 309 in which the respective positions of the multiple main scanning points 22 and the multiple sub-scanning points 25 are associated with the posture of the head 1. As illustrated in FIG. 22, the correspondence information 309 is, for example, a table in which three-dimensional position coordinates (x, y, z) are associated with posture information (A, B, C) of the head 1. The position coordinate x indicates a position in the X direction. The position coordinate y indicates a position in the Y direction. The position coordinate z indicates a position in the Z direction. The posture information A indicates a posture in the pitch direction pa. The posture information B indicates a posture in the yaw direction ya. The posture information C indicates a posture in the roll direction ra. The correspondence information 309 is predetermined by simulation or the like and stored in the storage 308.

The posture controller 306a controls the posture of the head 1 with reference to the correspondence information 309 stored in the storage 308 based on the information of the respective positions of the multiple main scanning points 22 and the multiple sub-scanning points 25.

In the present embodiment, the posture of the head 1 is controlled according to posture information (pb, yb, rb) acquired with reference to the predetermined correspondence information 309. Since the coating device according to the present embodiment does not calculate the posture of the head 1 every time the position of the head 1 changes due to the movement of the head 1, it is possible to control the posture of the head 1 by reducing the processing load of the controller 3a. Note that the correspondence information 309 is not necessarily stored in the controller 3a, and may be stored in an external server or the like communicably connected to the controller 3a. The posture controller 306a may acquire the posture information (pb, yb, rb) by referring to the correspondence information 309 stored in the external server. Effects other than the above in the present embodiment are substantially the same as those in the first embodiment.

### Third Embodiment

Next, a coating device according to a third embodiment will be described. The present embodiment is different from the first embodiment in that a controller controls a discharge timing of liquid from a head according to a distance between a target surface and a nozzle.

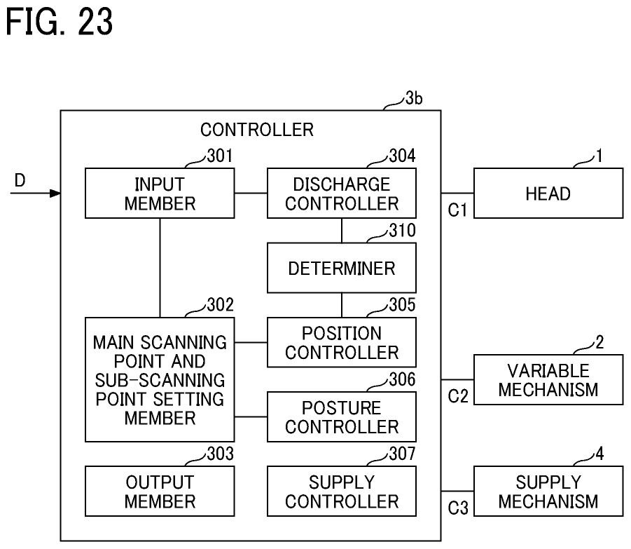

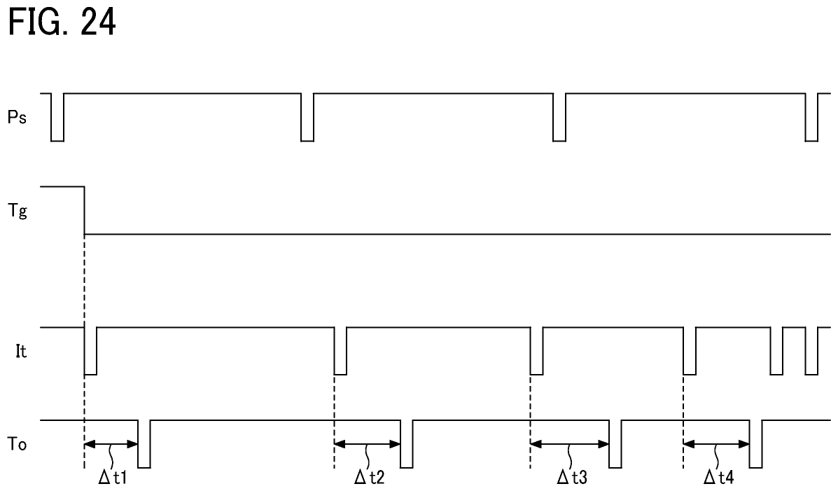

FIG. 23 is a block diagram illustrating one example of a functional configuration of a controller 3b included in the coating device according to the third embodiment. The controller 3b includes a determiner 310. The function of the determiner 310 is implemented by, for example, the CPU 31 illustrated in FIG. 2 loading a program stored in the ROM 32 into the RAM 33 and executing processing defined in the program.

The determiner 310 determines the discharge timing of the liquid from the head 1 according to the distance between the target surface 200 and the nozzle 311 of the head 1 in a manner of equalizing the thickness of the coating film at each position on the target surface 200. The discharge controller 304 discharges liquid according to the timing determined by the determiner 310 and applies the liquid to the target surface 200 to coat the target surface 200.

FIG. 24 is a diagram illustrating one example of a liquid discharge timing of the coating device according to the present embodiment. The description will be given with reference to FIG. 23 as appropriate.

The position controller 305 periodically outputs a head position signal Ps including the current three-dimensional position coordinates (x, y, z) and posture information (A, B, C) of the head 1 held by the variable mechanism 2 to the determiner 310. As one example, the unit of the three-dimensional position coordinates (x, y, z) is millimeter, and the unit of the posture information (A, B, C) is degree. In order to synchronize the operation of the variable mechanism 2 and the discharge operation of the head 1, a synchronization signal Tg is output from the position controller 305 to the determiner 310 at a position where liquid is discharged to start coating.

The determiner 310 generates an interval signal It for each interval to be coated from the head position signal Ps input from the position controller 305. In the example illustrated in FIG. 24, the determiner 310 generates the interval signal It every time 100 dpi (=0.254 mm) movement is made in the three-dimensional space. The determiner 310 outputs a discharge signal To indicating the discharge timing after a delay time Δti to the discharge controller 304 using the generated interval signal It as a trigger. The discharge controller 304 causes the head 1 to discharge liquid in response to the discharge signal To. The delay time Δti and the discharge signal To are variable according to the distance between the target surface 200 and the nozzle 311 determined based on the shape data D.

In the present embodiment, the controller 3b can equalize the thickness of the coating film at each position on the target surface 200 by controlling the discharge timing of the liquid from the head 1 according to the distance between the target surface 200 and the nozzle 311. “Equalize the thickness of the coating film at each position on the target surface 200” corresponds to, for example, making the thickness of the coating film substantially equal at each position on the target surface 200. Substantially equal means that the thickness may include a difference of ±10% or less. In the present embodiment, by equalizing the thickness of the coating film at each position on the target surface 200, the target surface 200 including the curved surface shape can be coated with high quality by the coating device 100 using the head 1 having the multiple nozzles 311 each discharging liquid. Note that effects other than the above are substantially the same as the effects of the first embodiment.

Although the preferred embodiments have been described in detail above, the present embodiment is not limited to the above-described embodiments, and various modifications and substitutions can be made to the above-described embodiments without departing from the scope recited in the claims.

The numbers such as ordinal number and quantity used in the description of the above embodiments are all illustrative for the purpose of specifically describing the technology of the present embodiment, and the present embodiment is not limited to the illustrative numbers. In addition, the connection relations among the components are illustrative for the purpose of specifically describing the technology of the present embodiment, and the connection relations for implementing functions of the present embodiment are not limited thereto.

The division of the blocks in the functional block diagram is one example, and multiple blocks may be implemented as one block, one block may be divided into multiple blocks, or some functions may be transferred to other blocks. In addition, functions of multiple blocks having similar functions may be processed in parallel or in a time division manner by a single hardware or software. Some or all of the functions may be distributed to multiple computers.

In the above embodiments, examples of the liquid discharged by the head 1 include a solution, a suspension, or an emulsion that contains, for example, a solvent, such as water or an organic solvent, a colorant, such as dye or pigment, a functional material, such as a polymerizable compound, a resin, or a surfactant, a biocompatible material, such as DNA, amino acid, protein, or calcium, or an edible material, such as a natural colorant. Such a solution, a suspension, or an emulsion can be used for, e.g., inkjet ink, coating paint, surface treatment solution, a liquid for forming components of electronic element or light-emitting element or a resist pattern of electronic circuit, or a material solution for three-dimensional fabrication.

The target surface 200 is a surface to which liquid adheres and sticks, a surface to which liquid adheres and permeates, or the like. Examples thereof include recording media, such as vehicle body, construction material, paper sheet, recording paper, recording sheet of paper, film, and cloth, electronic component, such as electronic substrate and piezoelectric element, and media, such as powder layer, organ model, and testing cell. The examples include any surface on which liquid can adhere, unless particularly limited.

Each function of the embodiments can be implemented by one processing circuit or multiple processing circuits. Here, the term “processing circuit” in the present description includes a programmed processor to execute each function by software, such as a processor implemented by an electronic circuit, and devices, such as an application specific integrated circuit (ASIC), a digital signal processor (DSP), a field programmable gate array (FPGA), and conventional circuit modules designed to implement the recited functions.

Aspects of the present embodiment are as follows, for example.

According to a first aspect, a coating device coats a target surface including a curved surface shape by a liquid discharge method, the coating device including: a head that includes multiple nozzles arranged on a nozzle surface side by side in a main scanning direction and discharges a liquid individually from the multiple nozzles; a variable mechanism that varies a relative position and a relative posture between the head and the target surface; and a controller that controls discharge of the liquid from the head and an operation of the variable mechanism, the controller controlling relative movement of the head in the main scanning direction in a manner that the head passes through multiple main scanning points set on a main scanning line which is an intersection line between the target surface and a cross section when the target surface is cut along a virtual plane which is predetermined, and controlling a relative posture of the head in a manner that a normal direction of a front surface of the head in the main scanning direction is along the main scanning direction in a yaw direction and a normal line of the nozzle surface is along the virtual plane in a roll direction.

According to a second aspect, in the coating device of the first aspect, the controller further controls movement of the head in a sub-scanning direction intersecting the main scanning direction, and the virtual plane includes one of multiple sub-scanning points set on a sub-scanning line passing through the main scanning points located in a region having a largest curvature radius of the target surface among the multiple main scanning points included in the main scanning line and extending in the sub-scanning direction.

According to a third aspect, in the coating device of the second aspect, the controller controls a posture of the head based on a correspondence information in which respective positions of the multiple main scanning points and the multiple sub-scanning points are associated with the posture of the head.

According to a fourth aspect, the coating device of the third aspect further includes a storage that stores the correspondence information, wherein the controller controls a posture of the head with reference to the correspondence information stored in the storage based on information of respective positions of the multiple main scanning points and the multiple sub-scanning points.

According to a fifth aspect, in the coating device of any of the first aspect to the fourth aspect, the controller controls the head to alternately perform continuous movement of the head in the main scanning direction and continuous movement of the head in a sub-scanning direction intersecting the main scanning direction and to discharge the liquid, and a length of a distance by which the head moves continuously once in the sub-scanning direction is shorter than a length of a coating width that is a width in the sub-scanning direction of a region to be coated by the head moving continuously once in the main scanning direction.

According to a sixth aspect, in the coating device of any of the first aspect to the fifth aspect, the controller moves the head in the main scanning direction in a manner that a normal direction of the nozzle surface is along a normal direction of the target surface in a pitch direction.

According to a seventh aspect, in the coating device of any of the first aspect to the sixth aspect, the controller moves the head in the main scanning direction in a manner that a distance between the nozzle surface and the target surface in a normal direction of the target surface is predetermined.

According to an eighth aspect, in the coating device of any of the first aspect to the seventh aspect, a normal direction of the target surface differs depending on a position of the target surface in the main scanning direction.

According to a ninth aspect, in the coating device of any of the first aspect to the eighth aspect, the target surface is a surface included in a vehicle body of an automobile.

According to a tenth aspect, in the coating device of any of the first aspect to the ninth aspect, the variable mechanism includes a robot arm having multiple drive shafts.

According to an eleventh aspect, in the coating device of any of the first aspect to the tenth aspect, the controller controls a discharge timing of the liquid from the head according to a distance between the target surface and the nozzle.

According to a twelfth aspect, a coating method is implemented by a coating device that coats a target surface including a curved surface shape by a liquid discharge method, the coating device discharging a liquid individually from multiple nozzles by a head including the multiple nozzles arranged on a nozzle surface side by side in a main scanning direction, varying a relative position and a relative posture between the head and the target surface by a variable mechanism, and controlling discharge of the liquid from the head and an operation of the variable mechanism by a controller, the controller controlling relative movement of the head in the main scanning direction in a manner that the head passes through multiple main scanning points set on a main scanning line which is an intersection line between the target surface and a cross section when the target surface is cut along a virtual plane which is predetermined, and controlling a relative posture of the head in a manner that a normal direction of a front surface of the head in the main scanning direction is along the main scanning direction in a yaw direction and a normal line of the nozzle surface is along the virtual plane in a roll direction.

According to a thirteenth aspect, a program causes a coating device that coats a target surface including a curved surface shape by a liquid discharge method to execute processing including: discharging a liquid individually from multiple nozzles by a head including the multiple nozzles arranged on a nozzle surface side by side in a main scanning direction; varying a relative position and a relative posture between the head and the target surface by a variable mechanism; and controlling discharge of the liquid by the head and an operation of the variable mechanism by a controller, the controller controlling relative movement of the head in the main scanning direction in a manner that the head passes through multiple main scanning points set on a main scanning line which is an intersection line between the target surface and a cross section when the target surface is cut along a virtual plane which is predetermined, and controlling a relative posture of the head in a manner that a normal direction of a front surface of the head in the main scanning direction is along the main scanning direction in a yaw direction and a normal line of the nozzle surface is along the virtual plane in a roll direction.

The above-described embodiments are illustrative and do not limit the present invention.

Thus, numerous additional modifications and variations are possible in light of the above teachings. For example, elements and/or features of different illustrative embodiments may be combined with each other and/or substituted for each other within the scope of the present invention.

This patent application is based on and claims priority to Japanese Patent Application No. 2023-063527, filed on Apr. 10, 2023, in the Japan Patent Office, the entire disclosure of which is hereby incorporated by reference herein.

### REFERENCE SIGNS LIST

1 head
1f front surface
2 variable mechanism
3, 3a, 3b controller
31 CPU
32 ROM
33 RAM
34 HDD/SSD
35 device connection I/F
36 communication I/F
4 supply mechanism
10 head center
11 ideal center track
11s ideal front nozzle track
11e ideal rear nozzle track
20 teaching point
21 virtual plane
22 main scanning point
23 main scanning line
24 sub-scanning line
25 sub-scanning point
100 coating device
101 moving direction
102 nozzle surface normal direction
200 target surface
200a target surface normal direction
301 input member
302 main scanning point and sub-scanning point setting member
303 output member
304 discharge controller
305 position controller
306, 306a posture controller
307 supply controller
308 storage
309 correspondence information
310 determiner
311 nozzle
311s front nozzle
311e rear nozzle
325 liquid
330 liquid tank
350 nozzle surface
C1 discharge control signal
C2 operation control signal
C3 supply control signal
D shape data
E line feed pitch
G1 to G7 discharge gap
pa pitch direction
ya yaw direction
ra roll direction
Ps head position signal
Tg synchronization signal
It interval signal
To discharge signal
Δt1 to Δt4 delay time
S system bus

### CITATION LIST

### Patent Literature

[PTL 1]

1. A coating device comprising:
a head having multiple nozzles arrayed on a nozzle surface in a nozzle array direction to discharge a liquid from each of the multiple nozzles in a discharge direction;
a multi-axis positioner to vary a relative position and a relative posture between the head and a target surface including a curved surface; and
control circuitry configured to:
set multiple main scanning points on a main scanning line, which is an intersection line between the target surface and a cross section cut along a virtual plane, in a main scanning direction;
control the multi-axis positioner to move the head relative to the target surface in the main scanning direction to pass through the multiple main scanning points;
control the multi-axis positioner to cause the nozzle array direction of the head to be along the main scanning direction to control a yaw direction of the head; and
control the multi-axis positioner to control the discharge direction of the head to be along the virtual plane to control a roll direction of the head.

2. The coating device according to claim 1, wherein the control circuitry:
controls the multi-axis positioner to move the head relative to the target surface in a sub-scanning direction intersecting the main scanning direction; and
sets multiple sub-scanning points on a sub-scanning line in the sub-scanning direction,
wherein the sub-scanning line including the multiple sub-scanning points passes through one of the multiple main scanning points having a largest curvature radius of the target surface among the multiple main scanning points in the main scanning line.

3. The coating device according to claim 2,
wherein the control circuitry controls the relative posture of the head based on:
a correspondence information in which respective positions of the multiple main scanning points and the multiple sub-scanning points are associated with the relative posture of the head.

4. The coating device according to claim 3, further comprising:
a storage to store the correspondence information,
wherein the control circuitry controls the relative posture of the head with reference to the correspondence information stored in the storage.

5. The coating device according to claim 1, wherein the control circuitry:
controls the multi-axis positioner to alternately perform:
continuously moving the head relative to the target surface in the main scanning direction; and
moving the head relative to the target surface in a sub-scanning direction intersecting the main scanning direction after one continuous movement of the head in the main scanning direction,
while causing the head to discharge the liquid,
the head moves relative to the target surface once in the sub-scanning direction for a line feed pitch,
the head moves continuously relative to the target surface in the main scanning direction while coating the target surface with a coating width in the sub-scanning direction, and
the line feed pitch is shorter than the coating width.

6. The coating device according to claim 1, wherein the control circuitry control the multi-axis positioner to:
move the head relative to the target surface in the main scanning direction; and
cause the discharge direction of the head to be along a normal direction of the target surface to control a pitch direction of the head.

7. The coating device according to claim 1, wherein the control circuitry moves the head relative to the target surface in the main scanning direction; and
keeps a distance between the nozzle surface and the target surface in a normal direction normal to the target surface to be a predetermined distance.

8. The coating device according to claim 1, wherein:
a normal direction of the target surface differs according to a position of the target surface in the main scanning direction.

9. The coating device according to claim 1, wherein:
the target surface includes a surface of a body of an automobile.

10. The coating device according to claim 1, wherein:
the multi-axis positioner includes a robot arm having multiple drive shafts.

11. The coating device according to claim 1, wherein:
the control circuitry controls the head to discharge the liquid at a discharge timing according to a distance between the target surface and the multiple nozzles.

12. A coating method comprising:
discharging a liquid in a discharge direction from each of multiple nozzles arrayed on a nozzle surface of a head in a nozzle array direction;
varying a relative position and a relative posture between the head and a target surface including a curved surface;
setting multiple main scanning points on a main scanning line, which is an intersection line between the target surface and a cross section cut along a virtual plane, in a main scanning direction;
moving the head relative to the target surface in the main scanning direction to pass through the multiple main scanning points;
controlling the nozzle array direction of the head to be along the main scanning direction to control a yaw direction of the head; and
controlling the discharge direction of the head to be along the virtual plane to control a roll direction of the head.

13. A non-transitory computer readable medium storing a program for causing a coating device to coat a target surface by performing a method comprising:
discharging a liquid in a discharge direction from each of multiple nozzles arrayed on a nozzle surface of a head in a nozzle array direction;
varying a relative position and a relative posture between the head and a target surface including a curved surface;
setting multiple main scanning points on a main scanning line, which is an intersection line between the target surface and a cross section cut along a virtual plane, in a main scanning direction;
moving the head relative to the target surface in the main scanning direction to pass through the multiple main scanning points;
controlling the nozzle array direction of the head to be along the main scanning direction to control a yaw direction of the head; and
controlling the discharge direction of the head to be along the virtual plane to control a roll direction of the head.
